(19) United States
(12) Patent Application Publication
(10) Pub. No.: US 2013/0242415 A1
(43) Pub. Date: Sep. 19, 2013

(54) IMAGING LENS AND IMAGING APPARATUS

(71) Applicant: SONY CORPORATION, Tokyo (JP)

(72) Inventor: Yasuhide Nihei, Kanagawa (JP)

(73) Assignee: SONY CORPORATION, Tokyo (JP)

(21) Appl. No.: 13/772,452

(22) Filed: Feb. 21, 2013

(30) Foreign Application Priority Data
Mar. 13, 2012 (JP) 2012-056250

(51) Int. Cl. G02B 9/60

(52) U.S. Cl. CPC G02B 9/60
USPC 359/764

(57) ABSTRACT

An imaging lens includes, in the order from an object side toward an image side: an aperture stop; a first lens having positive power and a concave image-side surface; a second lens having negative power and a concave object-side surface; a third lens having negative power; a fourth lens having positive power; and a fifth lens having negative power.

### FIELD

The present technology relates to an imaging lens and an imaging apparatus, and particularly to a technical field of an imaging lens suitable for a compact imaging apparatus and to an imaging apparatus with the imaging lens.

### BACKGROUND

There have been known mobile phones, digital still cameras, and other imaging apparatus with a camera using a CCD (charge coupled device), a CMOS (complementary metal oxide semiconductor) device, or any other solid-state imaging device.

As an imaging lens accommodated in an imaging apparatus of the type described above, a three-lens configuration or a four-lens configuration, due to insufficient aberration correction, may not provide improved optical performance that matches with increase in resolution and the number of pixels in recent years.

To solve the problem, an imaging lens having a five-lens configuration has been proposed (see JP-A-2011-209554, for example).

The imaging lens described in JP-A-2011-209554 includes a first lens having positive power, a second lens having negative power, a third lens having positive power, a fourth lens having positive power, and a fifth lens having negative power sequentially arranged from the object side toward the image side.

### SUMMARY

However, the imaging lens described in JP-A-2011-209554, which has a five-lens configuration for satisfactory correction of aberrations and improvement in optical performance, is thick not only because five lenses are provided but also because the third lens has positive power, resulting in a difficulty in shortening the total optical length and hence preventing size reduction.

It is therefore desirable to provide an imaging lens and an imaging apparatus that solve the problem described above and allow a decrease in total optical length with an improvement in optical performance achieved.

An embodiment of the present technology is directed to an imaging lens including, in the order from an object side toward an image side: an aperture stop, a first lens having positive power and a concave image-side surface, a second lens having negative power and a concave object-side surface, a third lens having negative power, a fourth lens having positive power, and a fifth lens having negative power.

The overall thickness of the imaging lens can therefore be reduced because the first lens and the second lens can be so disposed that the distance therebetween is minimized and the third lens has negative power.

In the imaging lens described above, it is preferable that the second lens has a concave image-side surface.

When the second lens has a concave image-side surface, the object-side surface and the image-side surface of the second lens cooperate to provide the negative power.

It is preferable that the imaging lens described above satisfies the conditional expression (1).

When the imaging lens satisfies the conditional expression (1), the power of the first lens becomes appropriate, and the field curvature and coma may be corrected in a well balanced manner.

It is preferable that the imaging lens described above satisfies the conditional expression (2).

When the imaging lens satisfies the conditional expression (2), the combined power of the first lens to the third lens becomes appropriate, and field curvature can be satisfactorily corrected.

It is preferable that the imaging lens described above satisfies the conditional expression (3).

When the imaging lens satisfies the conditional expression (3), the combined power of the second lens to the fourth lens becomes appropriate, and field curvature can be satisfactorily corrected.

It is preferable that the imaging lens described above satisfies the conditional expression (4).

When the imaging lens satisfies the conditional expression (4), the combined power of the third lens and the fourth lens becomes appropriate, and coma can be satisfactorily corrected.

In the imaging lens described above, it is preferable that each of the second lens and the third lens is made of a material having an Abbe number smaller than or equal to 31.

When each of the second lens and the third lens is made of a material having an Abbe number smaller than or equal to 31, chromatic aberrations can be satisfactorily corrected.

In the imaging lens described above, it is preferable that the upper limit of the conditional expression (2) is 1.4.

When the upper limit of the conditional expression (2) is 1.4, the combined power of the first lens to the third lens becomes more appropriate, and field curvature can be more satisfactorily corrected.

In the imaging lens described above, it is preferable that the upper limit of the conditional expression (4) is 2.25.

When the upper limit of the conditional expression (4) is 2.25, the combined power of the third lens and the fourth lens becomes more appropriate, and coma can be more satisfactorily corrected.

Another embodiment of the present technology is directed to an imaging apparatus including an imaging lens and an imaging device that converts an optical image formed by the imaging lens into an electric signal, and the imaging lens includes, in the order from an object side toward an image side: an aperture stop, a first lens having positive power and a concave image-side surface, a second lens having negative power and a concave object-side surface, a third lens having negative power, a fourth lens having positive power, and a fifth lens having negative power.

In the imaging lens of the imaging apparatus, the overall thickness of the imaging lens can therefore be reduced because the first lens and the second lens can be so disposed that the distance therebetween is minimized and the third lens has negative power.

The imaging lens according to the embodiment of the present technology includes, in the order from the object side toward the image side: the aperture stop, the first lens having positive power and the concave image-side surface, the second lens having negative power and the concave object-side surface, the third lens having negative power, the fourth lens having positive power, and the fifth lens having negative power.

Since the image-side surface of the first lens has a concave shape and the object-side surface of the second lens has a concave shape, the first lens and the second lens can be so disposed that the distance therebetween is minimized, whereby the total optical length can be shortened with an improvement in optical performance achieved.

In one preferred embodiment of the present technology described above, the second lens has a concave image-side surface.

Since the second lens is a biconcave lens, the second lens can be thinner than in a case where the second lens is formed as a negative lens with one surface of the second lens having a convex shape, whereby the total optical length can be further shortened.

In one preferred embodiment of the present technology described above, the imaging lens satisfies the following conditional expression (1):

0.45<f1/f4<0.70 (1)

where f1 represents the focal length of the first lens, and f4 represents the focal length of the fourth lens.

Therefore, not only does the power of the first lens become appropriate and the total optical length can be shortened, but also field curvature and coma are corrected in a well balanced manner so that the optical performance can be improved.

In one preferred embodiment of the present technology described above, the imaging lens satisfies the conditional expression (2).

Therefore, not only does the combined power of the first lens to the third lens become appropriate and the total optical length can be shortened, but also field curvature is satisfactorily corrected so that the optical performance can be improved.

In one preferred embodiment of the present technology described above, the imaging lens satisfies the conditional expression (3).

Therefore, not only does the combined power of the second lens to the fourth lens become appropriate and the total optical length can be shortened, but also coma and field curvature are corrected in a well balanced manner so that the optical performance can be improved.

In one preferred embodiment of the present technology described above, the imaging lens satisfies the conditional expression (4).

Therefore, not only does the combined power of the third lens and the fourth lens become appropriate and the total optical length can be shortened, but also coma is satisfactorily corrected so that the optical performance can be improved.

In one preferred embodiment of the present technology described above, each of the second lens and the third lens is made of a material having an Abbe number smaller than or equal to 31.

Chromatic aberrations can therefore be satisfactorily corrected so that the optical performance can be improved.

In one preferred embodiment of the present technology described above, the upper limit of the conditional expression (2) is 1.4.

Therefore, the total optical length can be shortened, and field curvature can be more satisfactorily corrected so that the optical performance can be further improved.

In one preferred embodiment of the present technology described above, the upper limit of the conditional expression (4) is 2.25.

Therefore, the total optical length can be shortened, and coma can be more satisfactorily corrected so that the optical performance can be further improved.

The imaging apparatus according to the embodiment of the present technology includes an imaging lens and an imaging device that converts an optical image formed by the imaging lens into an electric signal, and the imaging lens includes, in the order from an object side toward an image side: an aperture stop, a first lens having positive power and a concave image-side surface, a second lens having negative power and a concave object-side surface, a third lens having negative power, a fourth lens having positive power, and a fifth lens having negative power.

Since the image-side surface of the first lens has a concave shape and the object-side surface of the second lens has a concave shape in the imaging lens, the first lens and the second lens can be so disposed that the distance therebetween is minimized, whereby the total optical length can be shortened with an improvement in optical performance achieved.

### BRIEF DESCRIPTION OF THE DRAWINGS

FIG. 1 shows the lens configuration of an imaging lens according to Example 1;

FIG. 2 shows spherical aberration, astigmatism, and field curvature in a numerical example in which specific values are used in Example 1;

FIG. 3 shows the lens configuration of an imaging lens according to Example 2;

FIG. 4 shows spherical aberration, astigmatism, and field curvature in a numerical example in which specific values are used in Example 2;

FIG. 5 shows the lens configuration of an imaging lens according to Example 3;

FIG. 6 shows spherical aberration, astigmatism, and field curvature in a numerical example in which specific values are used in Example 3;

FIG. 7 shows the lens configuration of an imaging lens according to Example 4;

FIG. 8 shows spherical aberration, astigmatism, and field curvature in a numerical example in which specific values are used in Example 4;

FIG. 9, along with FIG. 10, shows a mobile phone based on an imaging apparatus according to an embodiment of the present technology and is a perspective view; and FIG. 10 is a block diagram.

### DETAILED DESCRIPTION

Embodiments of the present technology to provide an imaging lens and an imaging apparatus will be described below.

### [Configuration of Imaging Lens]

An imaging lens according to an embodiment of the present technology includes an aperture stop, a first lens having positive power and a concave image-side surface, a second lens having negative power and a concave object-side surface, a third lens having negative power, a fourth lens having positive power, and a fifth lens having negative power sequentially arranged from the object side toward the image side.

In the thus configured imaging lens according to the embodiment of the present technology, in which the aperture stop is disposed in a position shifted from the first lens toward the object side, an entrance pupil can be set in a position far away from the image plane, whereby a high degree of telecentricity can be ensured and hence the angle of incidence with respect to the image plane can be set in a preferable manner.

Further, in the imaging lens according to the embodiment of the present technology, which has a five-lens configuration formed of the first lens, the second lens, the third lens, the fourth lens, and the fifth lens, each of the lenses can be designed to correct one type of aberration, whereby the imaging lens as a whole can satisfactorily correct aberrations to improve its optical performance.

Moreover, in the imaging lens according to the embodiment of the present technology, in which the image-side surface of the first lens has a concave shape and the object-side surface of the second lens has a concave shape, the first lens and the second lens can be so disposed that the distance therebetween is minimized, whereby the total optical length can be shortened.

Still further, in the imaging lens according to the embodiment of the present technology, in which the third lens in the five-lens configuration has negative power, the overall thickness of the imaging lens can be reduced, whereby the total optical length can be further shortened.

As described above, the imaging lens according to the embodiment of the present technology, in which the aperture stop and the positive, negative, negative, positive, and negative five lenses are sequentially arranged from the object side toward the image side, and the image-side surface of the first lens has a concave shape and the object-side surface of the second lens has a concave shape, allows the total optical length to be shortened with an improvement in optical performance achieved.

In an imaging lens according to an embodiment of the present technology, the image-side surface of the second lens desirably has a concave surface.

When the image-side surface of the second lens, which has negative power and a concave object-side surface, also has a concave shape, the object-side and image-side surfaces cooperate to provide the negative power.

As described above, when the image-side surface of the second lens has a concave shape and hence the second lens is a biconcave lens, the second lens can be thinner than in a case where the second lens is formed as a negative lens with one surface of the second lens having a convex shape, whereby the total optical length can be further shortened.

An imaging lens according to an embodiment of the present technology desirably satisfies the following conditional expression (1):

0.45<f1/f4<0.70 (1)

where f1 represents the focal length of the first lens, and f4 represents the focal length of the fourth lens.

The conditional expression (1) defines the ratio of the focal length of the first lens to the focal length of the fourth lens.

When f1/f4 is greater than the upper limit of the conditional expression (1), the power of the first lens becomes too large. In this case, the field curvature and coma may not be corrected in a well balanced manner.

Conversely, when f1/f4 is smaller than the lower limit of the conditional expression (1), the power of the first lens becomes too small. In this case, the total optical length may not be shortened, and the field curvature and coma may not be corrected in a well balanced manner.

As described above, when the imaging lens satisfies the conditional expression (1), not only can the total optical length be shortened but also the field curvature and coma can be corrected in a well balanced manner so that the optical performance is improved. Further, the positive power of the imaging lens can be formed by multiple lenses having positive power, whereby high-volume productivity can be ensured because the sensitivity to decentering decreases.

An imaging lens according to an embodiment of the present technology desirably satisfies the following conditional expression (2):

0.9<f123/fa<1.5 (2)

where f123 represents the combined focal length of the first lens, the second lens, and the third lens, and fa represents the focal length of the entire lens system.

The conditional expression (2) defines the ratio of the combined focal length of the first lens to the third lens to the focal length of the entire lens system.

When f123/fa is greater than the upper limit of the conditional expression (2), the combined power of the first lens to the third lens becomes too large. In this case, field curvature may not be satisfactorily corrected.

Conversely, when f123/fa is smaller than the lower limit of the conditional expression (2), the combined power of the first lens to the third lens becomes too small. In this case, the total optical length may not be shortened, and field curvature may not be satisfactorily corrected.

As described above, when the imaging lens satisfies the conditional expression (2), the total optical length can be shortened, and field curvature can be satisfactorily corrected so that the optical performance can be improved.

In the present technology, the numerical range of the conditional expression (2) is more preferably changed to the range of the following conditional expression (2)′:

0.9<f123/fa<1.4. (2)′

When the imaging lens satisfies the conditional expression (2)′, the total optical length can be shortened, and field curvature can be more satisfactorily corrected so that the optical performance can be further improved.

An imaging lens according to an embodiment of the present technology desirably satisfies the following conditional expression (3):

1.5<f234/fa<9.0 (3)

where f234 represents the combined focal length of the second lens, the third lens, and the fourth lens, and fa represents the focal length of the entire lens system.

The conditional expression (3) defines the ratio of the combined focal length of the second lens to the fourth lens to the focal length of the entire lens system.

When f234/fa is greater than the upper limit of the conditional expression (3), the combined power of the second lens to the fourth lens becomes too large. In this case, coma and field curvature may not be corrected in a well balanced manner.

Conversely, when f234/fa is smaller than the lower limit of the conditional expression (3), the combined power of the second lens to the fourth lens becomes too small. In this case, the total optical length may not be shortened, and coma and field curvature may not be corrected in a well balanced manner.

As described above, when the imaging lens satisfies the conditional expression (3), the total optical length can be shortened, and coma and field curvature can be corrected in a well balanced manner so that the optical performance can be improved.

An imaging lens according to an embodiment of the present technology desirably satisfies the following conditional expression (4):

1.5<f34/fa<2.5 (4)

where f34 represents the combined focal length of the third lens and the fourth lens, and fa represents the focal length of the entire lens system.

The conditional expression (4) defines the ratio of the combined focal length of the third lens and the fourth lens to the focal length of the entire lens system.

When f34/fa is greater than the upper limit of the conditional expression (4), the combined power of the third lens and the fourth lens becomes too large. In this case, coma may not be satisfactorily corrected.

Conversely, when f34/fa is smaller than the lower limit of the conditional expression (4), the combined power of the third lens and the fourth lens becomes too small. In this case, the total optical length may not be shortened, and coma may not be satisfactorily corrected.

As described above, when the imaging lens satisfies the conditional expression (4), the total optical length can be shortened, and coma can be satisfactorily corrected so that the optical performance can be improved.

In the present technology, the numerical range of the conditional expression (4) is more preferably changed to the range of the following conditional expression (4)′:

1.5<f34/fa<2.25. (4)′

When the imaging lens satisfies the conditional expression (4)′, the total optical length can be shortened, and coma can be more satisfactorily corrected so that the optical performance can be further improved.

In an imaging lens according to an embodiment of the present technology, each of the second lens and the third lens is desirably made of a material having an Abbe number smaller than or equal to 31.

When each of the second lens and the third lens is made of a material having an Abbe number smaller than or equal to 31, chromatic aberrations can be satisfactorily corrected so that the optical performance can be improved. Further, when the second lens and the third lens are made of the same material, the material cost of forming the lenses is lowered, whereby the cost of manufacturing imaging lens can be lowered.

### [Numerical Example of Imaging Lens]

Specific examples of the imaging lenses according to the embodiments of the present technology and numerical examples in which specific values are used in the examples will be described below with reference to the drawings and tables.

The meanings of the symbols shown in the following tables and descriptions and other information on the symbols are as follows.

“Si” denotes a surface number of an i-th surface counted from the object side toward the image side. “Ri” denotes the paraxial radius of curvature of an i-th surface. “Di” denotes an on-axis inter-surface distance (central thickness of lens or air separation between lenses) between an i-th surface and an (i+1)-th surface. “Ni” denotes the refractive index of a lens or any other optical component having an i-th surface as a front surface at the d line (λ=587.6 nm). “νi” denotes the Abbe number of a lens or any other optical component having an i-th surface as a front surface at the d line.

In the field of “Ri”, “INFINITY” indicates that the surface is a flat surface.

“κ” denotes a conic constant, and “A3” to “A16” denote third to sixteenth aspheric coefficients, respectively.

“Fno” denotes an f-number. “f” denotes a focal length. “ω” denotes a half viewing angle.

Some imaging lenses used in the following examples have an aspheric lens surface. The shape of an aspheric surface is defined by the following Expressions 1 and 2 with the following definitions: “x” denotes the distance from the vertex of the lens surface along the optical axis (the amount of sag); “y” denotes the height in the direction perpendicular to the optical axis direction (image height); “c” denotes the paraxial curvature (reciprocal of radius of curvature) at the vertex of the lens surface; “κ” denotes the conic constant; and “A3” to “A16” denote third to sixteenth aspheric coefficients, respectively.

It is noted that Expression 1 expresses an aspheric surface by using only even-order aspheric constants, and Expression 2 expresses an aspheric surface by using even-order and odd-order aspheric constants.

$$\begin{matrix}x = \frac{{cy}^{2}}{1 + \sqrt{1 - ( 1 + κ ) {c}^{2} {y}^{2}}} + A 4 {y}^{4} + A 6 {y}^{6} + A 8 {y}^{8} + A 10 {y}^{10} + A 12 {y}^{12} + A 14 {y}^{14} + A 16 {y}^{16} & [ Expression 1 ] \\ x = \frac{{cy}^{2}}{1 + \sqrt{1 - ( 1 + κ ) {c}^{2} {y}^{2}}} + A 3 {y}^{3} + A 4 {y}^{4} + A 5 {y}^{5} + A 6 {y}^{6} + A 7 {y}^{7} + A 8 {y}^{8} + A 9 {y}^{9} + A 10 {y}^{10} + A 11 {y}^{11} + A 12 {y}^{12} & [ Expression 2 ]\end{matrix}$$

In the figure showing the configuration of each imaging lens, “AX” represents the optical axis.

### EXAMPLE 1

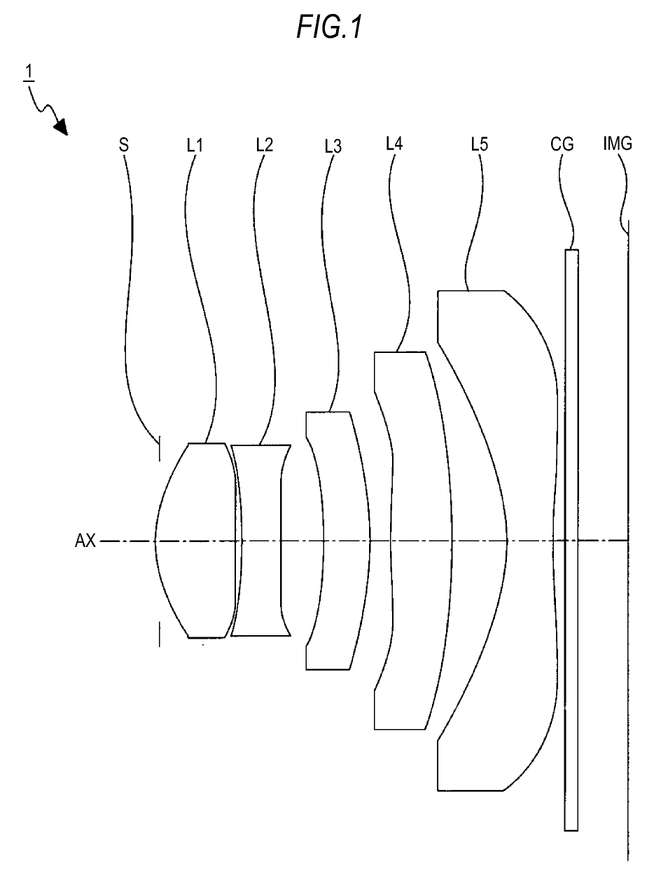

FIG. 1 shows the lens configuration of an imaging lens 1 according to Example 1 of the present technology.

The imaging lens 1 includes an aperture stop S, a first lens L1 having positive power, a second lens L2 having negative power, a third lens L3 having negative power, a fourth lens L4 having positive power, and a fifth lens L5 having negative power sequentially arranged from the object side toward the image side.

The first lens L1 has a convex object-side surface S1 and a concave image-side surface S2.

The second lens L2 has a concave object-side surface S3 and a convex image-side surface S4.

The third lens L3 has a concave object-side surface S5 and a convex image-side surface S6.

The fourth lens L4 has a convex object-side surface S7 and a convex image-side surface S8.

The fifth lens L5 has a concave object-side surface S9 and a concave image-side surface S10.

The aperture stop S, the first lens L1, the second lens L2, the third lens L3, the fourth lens L4, and the fifth lens L5 are disposed in fixed positions.

A cover glass plate CG is disposed between the fifth lens L5 and an image plane IMG.

Table 1 shows lens data in Numerical Example 1 in which specific values are used in the imaging lens 1 according to Example 1.

TABLE 1

| Si | Ri | Di | Ni | νi |
|---|---|---|---|---|
| 1 | 1.810 | 0.976 | 1.53 | 54.2 |
| 2 | 37.238 | 0.080 | | |
| 3 | −5.352 | 0.480 | 1.63 | 23.9 |
| 4 | −19.922 | 0.544 | | |
| 5 | −6.572 | 0.544 | 1.63 | 23.9 |
| 6 | −12.816 | 0.288 | | |
| 7 | 13.421 | 0.736 | 1.53 | 54.2 |
| 8 | −4.639 | 0.672 | | |
| 9 | −3.036 | 0.560 | 1.53 | 54.2 |
| 10 | 5.609 | 0.170 | | |
| 11 | INF | 0.160 | 1.5167 | 64.2 |
| 12 | INF | 0.600 | | |

In the imaging lens 1, the following surfaces are aspheric surfaces: both surfaces of the first lens L1 (first and second surfaces); both surfaces of the second lens L2 (third and fourth surfaces); both surfaces of the third lens L3 (fifth and sixth surfaces); both surfaces of the fourth lens L4 (seventh and eighth surfaces); and both surfaces of the fifth lens L5 (ninth and tenth surfaces). Tables 2 and 3 show the third to sixteenth aspheric coefficients A3 to A16 and the conic constant κ of the aspheric surfaces in Numerical Example 1.

Table 2 shows only the even-order aspheric constants, and Table 3 shows the even-order and odd-order aspheric constants.

TABLE 2

| Si | κ | Fourth | Sixth | Eighth | Tenth | Twelfth | Fourteenth | Sixteenth |
|---|---|---|---|---|---|---|---|---|
| 1 | 0.3000 | −1.010E−02 | 5.527E−03 | −1.505E−02 | 4.650E−03 | 3.635E−03 | −3.327E−03 | −8.231E−05 |
| 2 | 0.0000 | −1.841E−02 | −6.428E−03 | −2.588E−02 | −1.163E−02 | 9.907E−03 | 5.647E−03 | −3.274E−03 |
| 9 | −0.6400 | 3.056E−03 | 5.185E−04 | 8.566E−06 | −9.511E−07 | 0.000E+00 | 0.000E+00 | 0.000E+00 |

TABLE 3

| Si | κ | Third | Fourth | Fifth | Sixth | Seventh |
|---|---|---|---|---|---|---|
| 3 | 13.0000 | 4.145E−02 | 5.513E−02 | −1.102E−01 | 2.235E+00 | −5.044E+00 |
| 4 | 0.0000 | 6.261E−02 | 4.333E−02 | 6.146E−01 | 1.916E−01 | −5.131E−01 |
| 5 | 23.0000 | −4.719E−03 | −6.603E−02 | −7.354E−02 | 2.606E−01 | 1.172E−01 |
| 6 | 0.0000 | −3.388E−02 | −2.835E−01 | −2.454E−02 | 1.716E−02 | 1.870E−01 |
| 7 | 0.0000 | 1.752E−01 | −6.389E−01 | 2.537E−01 | −7.842E−02 | 2.004E−02 |
| 8 | 0.0000 | 2.264E−01 | −8.703E−02 | 1.287E−02 | −6.468E−03 | 2.447E−03 |
| 10 | −61.0000 | −2.957E−02 | −3.038E−02 | −1.337E−03 | 9.987E−03 | −3.371E−03 |

| Si | Eighth | Ninth | Tenth | Eleventh | Twelfth |
|---|---|---|---|---|---|
| 3 | 3.602E+00 | −3.122E+00 | 3.045E+00 | 0.000E+00 | 0.000E+00 |
| 4 | −5.599E−01 | −2.700E−01 | 2.097E+00 | 0.000E+00 | 0.000E+00 |
| 5 | −9.216E−01 | 1.349E+00 | −7.631E−01 | 0.000E+00 | 0.000E+00 |
| 6 | 1.688E−01 | −4.628E−02 | −1.206E−01 | 0.000E+00 | 0.000E+00 |
| 7 | 5.418E−02 | 3.043E−02 | −1.994E−02 | −2.056E−02 | 7.867E−03 |
| 8 | −1.328E−03 | −3.862E−03 | 2.015E−03 | −1.106E−04 | 1.016E−04 |
| 10 | −5.548E−03 | 1.050E−04 | 8.539E−04 | 0.000E+00 | 0.000E+00 |

Table 4 shows the focal length f, the f-number Fno, and the half viewing angle ω in Numerical Example 1.

TABLE 4

| | |
|---|---|
| f | 5.25 |
| Fno | 2.4 |
| ω (°) | 35 |

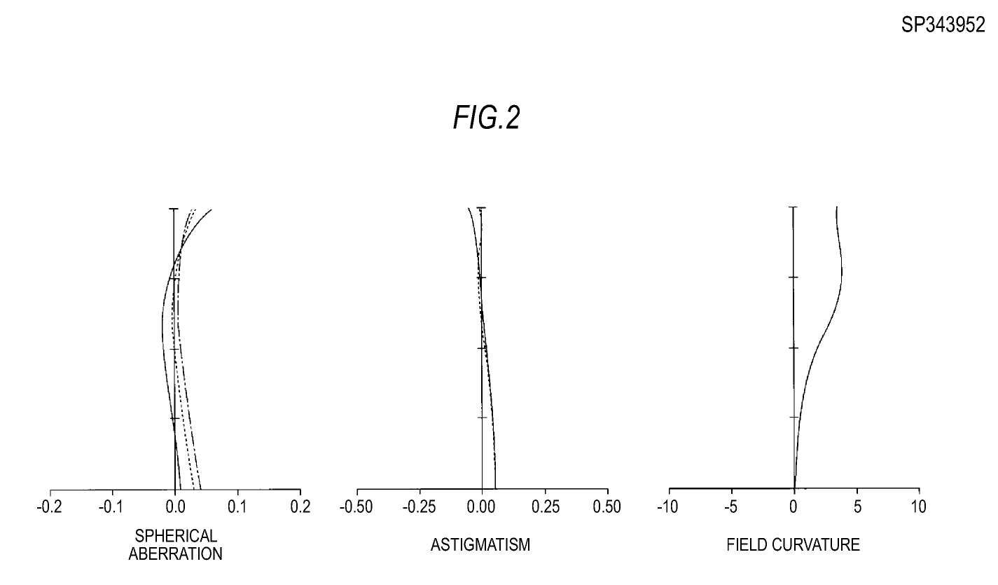

FIG. 2 shows aberrations in Numerical Example 1.

In the spherical aberration diagram in FIG. 2, the vertical axis represents the proportion with respect to the full-aperture f-number, and the horizontal axis represents the amount of defocus. The solid line represents spherical aberration values at the g line (wavelength of 435.83 nm), the dotted line represents spherical aberration values at the d line (wavelength of 587.56 nm), and the chain line represents spherical aberration values at the F line (wavelength of 486.13 nm). In the astigmatism diagram in FIG. 2, the vertical axis represents the viewing angle, and the horizontal axis represents the amount of defocus. The solid line represents astigmatism values in the sagittal image plane at the d line, and the broken line represents astigmatism values in the meridional image plane at the d line. In the field curvature diagram in FIG. 2, the vertical axis represents the viewing angle, and the horizontal axis represents %. The solid line represents field curvature values at the d line.

The aberration diagrams clearly show that the aberrations have been satisfactorily corrected and excellent imaging performance has been achieved in Numerical Example 1.

### EXAMPLE 2

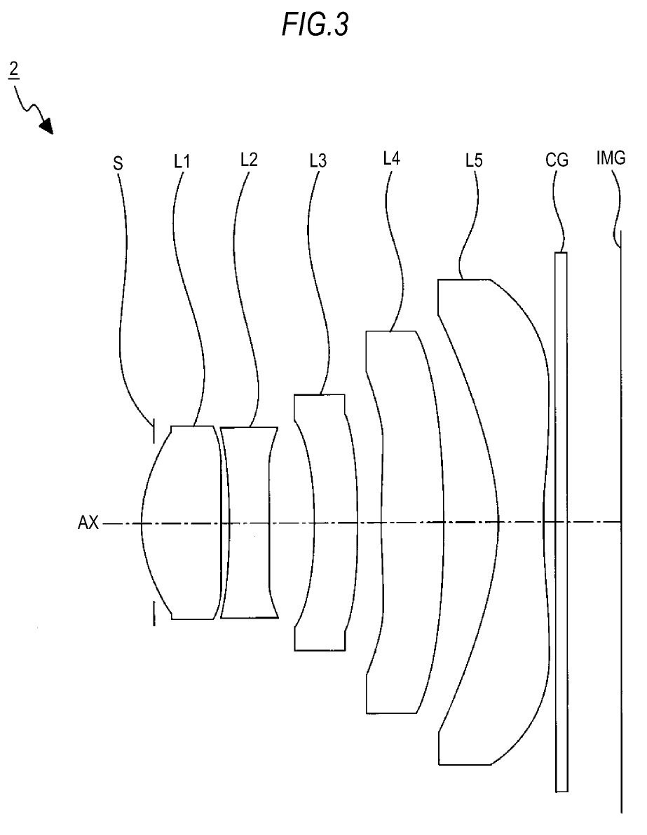

FIG. 3 shows the lens configuration of an imaging lens 2 according to Example 2 of the present technology.

The imaging lens 2 includes an aperture stop S, a first lens L1 having positive power, a second lens L2 having negative power, a third lens L3 having negative power, a fourth lens L4 having positive power, and a fifth lens L5 having negative power sequentially arranged from the object side toward the image side.

The first lens L1 has a convex object-side surface S1 and a concave image-side surface S2.

The second lens L2 has a concave object-side surface S3 and a convex image-side surface S4.

The third lens L3 has a concave object-side surface S5 and a convex image-side surface S6.

The fourth lens L4 has a convex object-side surface S7 and a convex image-side surface S8.

The fifth lens L5 has a concave object-side surface S9 and a concave image-side surface S10.

The aperture stop S, the first lens L1, the second lens L2, the third lens L3, the fourth lens L4, and the fifth lens L5 are disposed in fixed positions.

A cover glass plate CG is disposed between the fifth lens L5 and the image plane IMG.

Table 5 shows lens data in Numerical Example 2 in which specific values are used in the imaging lens 2 according to Example 2.

TABLE 5

| Si | Ri | Di | Ni | νi |
|---|---|---|---|---|
| 1 | 1.697 | 0.915 | 1.53 | 54.2 |
| 2 | 53.589 | 0.075 | | |
| 3 | −5.635 | 0.450 | 1.63 | 23.9 |
| 4 | −33.966 | 0.510 | | |
| 5 | −6.061 | 0.510 | 1.63 | 23.9 |
| 6 | −14.513 | 0.270 | | |
| 7 | 9.825 | 0.690 | 1.53 | 54.2 |
| 8 | −5.692 | 0.630 | | |
| 9 | −3.186 | 0.525 | 1.53 | 54.2 |
| 10 | 5.352 | 0.110 | | |
| 11 | INF | 0.150 | 1.5167 | 64.2 |
| 12 | INF | 0.600 | | |

In the imaging lens 2, the following surfaces are aspheric surfaces: both surfaces of the first lens L1 (first and second surfaces); both surfaces of the second lens L2 (third and fourth surfaces); both surfaces of the third lens L3 (fifth and sixth surfaces); both surfaces of the fourth lens L4 (seventh and eighth surfaces); and both surfaces of the fifth lens L5 (ninth and tenth surfaces). Tables 6 and 7 show the third to sixteenth aspheric coefficients A3 to A16 and the conic constant κ of the aspheric surfaces in Numerical Example 2.

Table 6 shows only the even-order aspheric constants, and Table 7 shows the even-order and odd-order aspheric constants.

TABLE 6

| Si | κ | Fourth | Sixth | Eighth | Tenth | Twelfth | Fourteenth | Sixteenth |
|---|---|---|---|---|---|---|---|---|
| 1 | 0.3000 | −1.351E−02 | 6.198E−03 | −2.540E−02 | 8.196E−03 | 8.532E−03 | −8.343E−03 | −2.339E−04 |
| 2 | 0.0000 | −2.059E−02 | −3.844E−03 | −4.094E−02 | −2.274E−02 | 1.961E−02 | 1.358E−02 | −8.844E−03 |
| 9 | −0.6400 | 3.805E−03 | 6.380E−04 | 9.235E−06 | −2.538E−06 | 0.000E+00 | 0.000E+00 | 0.000E+00 |

TABLE 7

| Si | κ | Third | Fourth | Fifth | Sixth | Seventh |
|---|---|---|---|---|---|---|
| 3 | 13.0000 | 3.890E−02 | 4.230E−02 | −8.381E−02 | 2.110E+00 | −4.742E+00 |
| 4 | 0.0000 | 5.895E−02 | −6.817E−03 | 6.160E−01 | 1.893E−01 | −5.493E−01 |
| 5 | 23.0000 | −9.523E−03 | −1.262E−01 | −6.575E−02 | 2.949E−01 | 1.688E−01 |
| 6 | 0.0000 | −7.908E−02 | −2.454E−01 | 2.606E−03 | 2.437E−02 | 1.931E−01 |
| 7 | 0.0000 | 1.048E−01 | −5.865E−01 | 2.583E−01 | −6.527E−02 | 1.992E−02 |
| 8 | 0.0000 | 1.888E−01 | −9.420E−02 | 7.938E−03 | −8.415E−03 | 1.668E−03 |
| 10 | −61.0000 | −2.317E−02 | −2.748E−02 | −4.629E−03 | 7.190E−03 | −3.906E−03 |

| Si | Eighth | Ninth | Tenth | Eleventh | Twelfth |
|---|---|---|---|---|---|
| 3 | 3.388E+00 | −2.943E+00 | 2.769E+00 | 0.000E+00 | 0.000E+00 |
| 4 | −6.363E−01 | −2.886E−01 | 2.129E+00 | 0.000E+00 | 0.000E+00 |
| 5 | −8.955E−01 | 1.105E+00 | −6.788E−01 | 0.000E+00 | 0.000E+00 |
| 6 | 1.745E−01 | −3.537E−02 | −1.177E−01 | 0.000E+00 | 0.000E+00 |
| 7 | 4.780E−02 | 2.578E−02 | −2.013E−02 | −1.907E−02 | 8.832E−03 |
| 8 | −1.226E−03 | −3.492E−03 | 1.954E−03 | −9.104E−05 | 8.215E−05 |
| 10 | −5.422E−03 | 1.993E−04 | 7.624E−04 | 0.000E+00 | 0.000E+00 |

Table 8 shows the focal length f, the f-number Fno, and the half viewing angle ω in Numerical Example 2.

TABLE 8

| | |
|---|---|
| f | 5.01 |
| Fno | 2.4 |
| ω (°) | 35 |

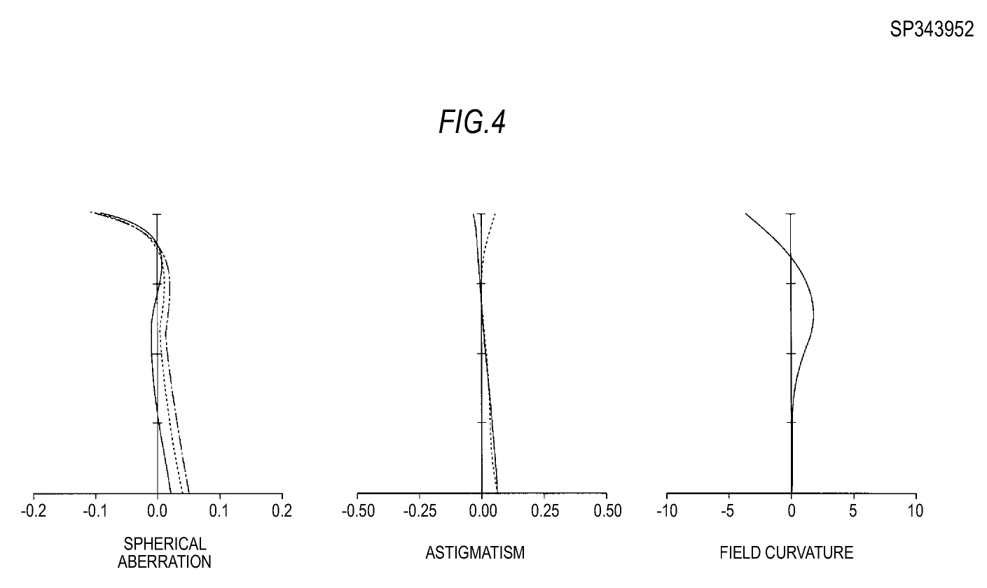

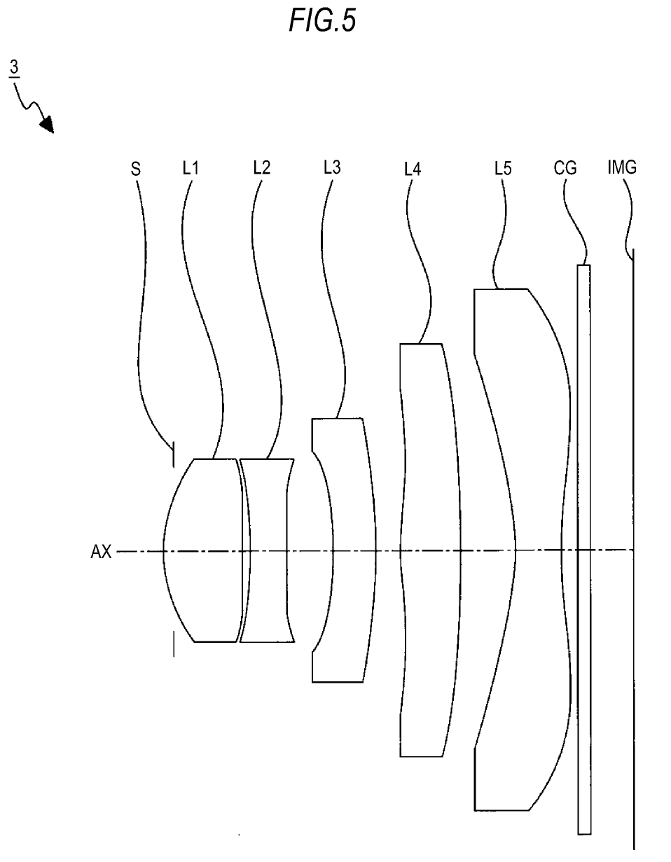

FIG. 4 shows aberrations in Numerical Example 2.

In the spherical aberration diagram in FIG. 4, the vertical axis represents the proportion with respect to the full-aperture f-number, and the horizontal axis represents the amount of defocus. The solid line represents spherical aberration values at the g line (wavelength of 435.83 nm), the dotted line represents spherical aberration values at the d line (wavelength of 587.56 nm), and the chain line represents spherical aberration values at the F line (wavelength of 486.13 nm). In the astigmatism diagram in FIG. 4, the vertical axis represents the viewing angle, and the horizontal axis represents the amount of defocus. The solid line represents astigmatism values in the sagittal image plane at the d line, and the broken line represents astigmatism values in the meridional image plane at the d line. In the field curvature diagram in FIG. 4, the vertical axis represents the viewing angle, and the horizontal axis represents %. The solid line represents field curvature values at the d line.

The aberration diagrams clearly show that the aberrations have been satisfactorily corrected and excellent imaging performance has been achieved in Numerical Example 2.

### EXAMPLE 3

FIG. 5 shows the lens configuration of an imaging lens 3 according to Example 3 of the present technology.

The imaging lens 3 includes an aperture stop S, a first lens L1 having positive power, a second lens L2 having negative power, a third lens L3 having negative power, a fourth lens L4 having positive power, and a fifth lens L5 having negative power sequentially arranged from the object side toward the image side.

The first lens L1 has a convex object-side surface S1 and a concave image-side surface S2.

The second lens L2 has a concave object-side surface S3 and a convex image-side surface S4.

The third lens L3 has a concave object-side surface S5 and a convex image-side surface S6.

The fourth lens L4 has a convex object-side surface S7 and a convex image-side surface S8.

The fifth lens L5 has a concave object-side surface S9 and a concave image-side surface S10.

The aperture stop S, the first lens L1, the second lens L2, the third lens L3, the fourth lens L4, and the fifth lens L5 are disposed in fixed positions.

A cover glass plate CG is disposed between the fifth lens L5 and the image plane IMG.

Table 9 shows lens data in Numerical Example 3 in which specific values are used in the imaging lens 3 according to Example 3.

TABLE 9

| Si | Ri | Di | Ni | νi |
|---|---|---|---|---|
| 1 | 1.701 | 0.915 | 1.53 | 54.2 |
| 2 | 22.679 | 0.075 | | |
| 3 | −5.072 | 0.450 | 1.63 | 23.9 |
| 4 | −14.643 | 0.510 | | |
| 5 | −5.424 | 0.510 | 1.63 | 23.9 |
| 6 | −34.107 | 0.270 | | |
| 7 | 4.204 | 0.690 | 1.53 | 54.2 |
| 8 | −8.540 | 0.630 | | |
| 9 | −3.914 | 0.525 | 1.53 | 54.2 |
| 10 | 4.738 | 0.210 | | |
| 11 | INF | 0.1500 | 1.5167 | 64.2 |
| 12 | INF | 0.5000 | | |

In the imaging lens 3, the following surfaces are aspheric surfaces: both surfaces of the first lens L1 (first and second surfaces); both surfaces of the second lens L2 (third and fourth surfaces); both surfaces of the third lens L3 (fifth and sixth surfaces); both surfaces of the fourth lens L4 (seventh and eighth surfaces); and both surfaces of the fifth lens L5 (ninth and tenth surfaces). Tables 10 and 11 show the third to sixteenth aspheric coefficients A3 to A16 and the conic constant κ of the aspheric surfaces in Numerical Example 3.

Table 10 shows only the even-order aspheric constants, and Table 11 shows the even-order and odd-order aspheric constants.

TABLE 10

| Si | κ | Fourth | Sixth | Eighth | Tenth | Twelfth | Fourteenth | Sixteenth |
|---|---|---|---|---|---|---|---|---|
| 1 | 0.3004 | −1.209E−02 | 6.762E−03 | −2.355E−02 | 8.924E−03 | 7.91E−03 | −7.54E−03 | −2.23E−04 |
| 2 | 0.0000 | −2.323E−02 | −7.790E−03 | −4.107E−02 | −2.139E−02 | 2.04E−02 | 1.38E−02 | −8.28E−03 |
| 9 | −0.9503 | 4.822E−03 | 6.835E−04 | 1.726E−06 | −3.012E−06 | 0.000E+00 | 0.000E+00 | 0.000E+00 |

TABLE 11

| Si | κ | Third | Fourth | Fifth | Sixth | Seventh |
|---|---|---|---|---|---|---|
| 3 | 13.2500 | 4.38E−02 | 4.58E−02 | −1.17E−01 | 2.08E+00 | −4.73E+00 |
| 4 | 0.0000 | 5.77E−02 | 3.43E−02 | 5.53E−01 | 1.44E−01 | −5.21E−01 |
| 5 | 20.9692 | 3.85E−02 | −6.81E−02 | −8.74E−02 | 2.26E−01 | 9.73E−02 |
| 6 | 0.0000 | −4.80E−02 | −2.56E−01 | −1.61E−02 | 2.25E−02 | 1.80E−01 |
| 7 | 0.0000 | 1.07E−01 | −5.97E−01 | 2.48E−01 | −6.97E−02 | 1.95E−02 |
| 8 | 0.0000 | 2.01E−01 | −1.09E−01 | −4.79E−03 | −7.78E−03 | 3.95E−03 |
| 10 | −52.6900 | 2.13E−02 | −3.84E−02 | −6.92E−03 | 9.10E−03 | −2.57E−03 |

| Si | Eighth | Ninth | Tenth | Eleventh | Twelfth |
|---|---|---|---|---|---|
| 3 | 3.40E+00 | −2.87E+00 | 2.94E+00 | 0.000E+00 | 0.000E+00 |
| 4 | −5.58E−01 | −2.65E−01 | 1.99E+00 | 0.000E+00 | 0.000E+00 |
| 5 | −8.68E−01 | 1.27E+00 | −7.19E−01 | 0.000E+00 | 0.000E+00 |
| 6 | 1.60E−01 | −4.54E−02 | −1.18E−01 | 0.000E+00 | 0.000E+00 |
| 7 | 5.08E−02 | 2.85E−02 | −1.86E−02 | −1.92E−02 | 7.31E−03 |
| 8 | 2.14E−04 | −2.81E−03 | 2.25E−03 | 2.37E−05 | 1.17E−04 |
| 10 | −4.87E−03 | 2.22E−04 | 8.37E−04 | 0.00E+00 | 0.00E+00 |

Table 12 shows the focal length f, the f-number Fno, and the half viewing angle ω in Numerical Example 3.

TABLE 12

| | |
|---|---|
| f | 4.90 |
| Fno | 2.4 |
| ω (°) | 35 |

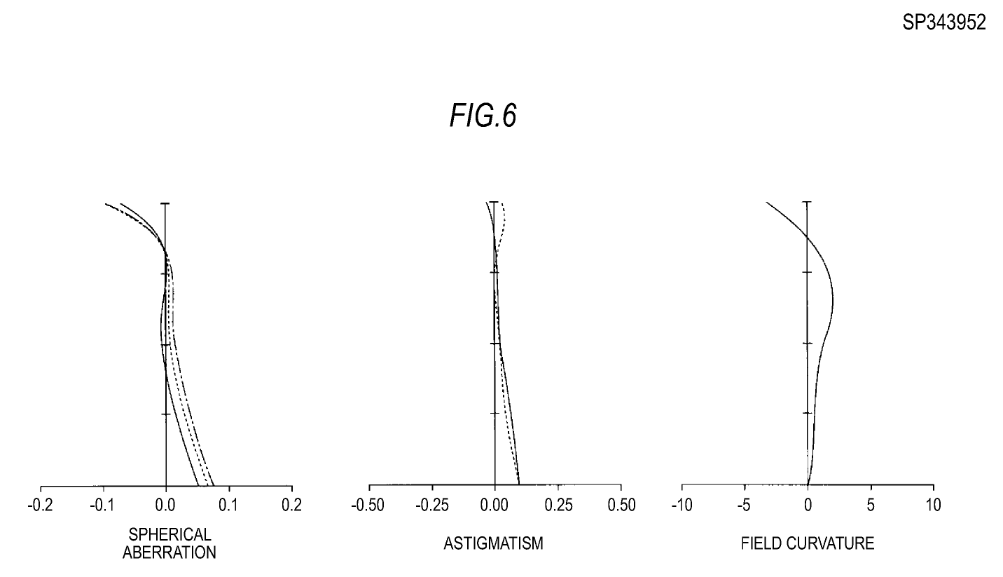

FIG. 6 shows aberrations in Numerical Example 3.

In the spherical aberration diagram in FIG. 6, the vertical axis represents the proportion with respect to the full-aperture f-number, and the horizontal axis represents the amount of defocus. The solid line represents spherical aberration values at the g line (wavelength of 435.83 nm), the dotted line represents spherical aberration values at the d line (wavelength of 587.56 nm), and the chain line represents spherical aberration values at the F line (wavelength of 486.13 nm). In the astigmatism diagram in FIG. 6, the vertical axis represents the viewing angle, and the horizontal axis represents the amount of defocus. The solid line represents astigmatism values in the sagittal image plane at the d line, and the broken line represents astigmatism values in the meridional image plane at the d line. In the field curvature diagram in FIG. 6, the vertical axis represents the viewing angle, and the horizontal axis represents %. The solid line represents field curvature values at the d line.

The aberration diagrams clearly show that the aberrations have been satisfactorily corrected and excellent imaging performance has been achieved in Numerical Example 3.

### EXAMPLE 4

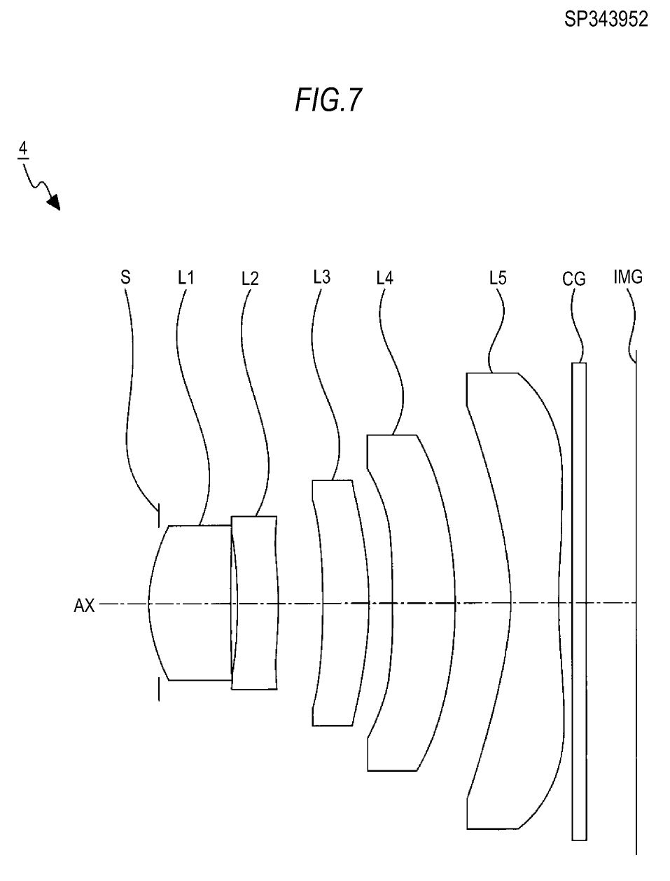

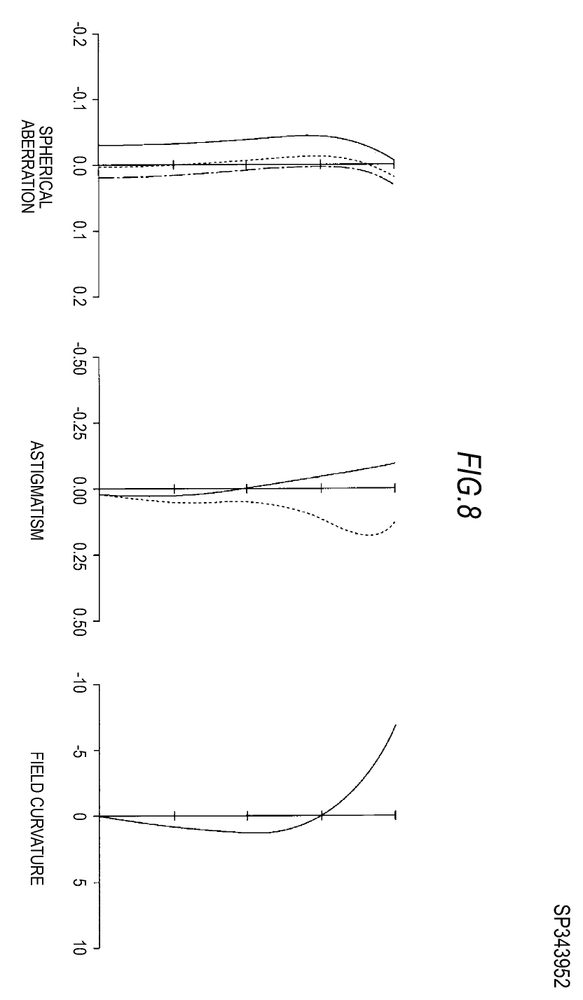

FIG. 7 shows the lens configuration of an imaging lens 4 according to Example 4 of the present technology.

The imaging lens 4 includes an aperture stop S, a first lens L1 having positive power, a second lens L2 having negative power, a third lens L3 having negative power, a fourth lens L4 having positive power, and a fifth lens L5 having negative power sequentially arranged from the object side toward the image side.

The first lens L1 has a convex object-side surface S1 and a concave image-side surface S2.

The second lens L2 has a concave object-side surface S3 and a convex image-side surface S4.

The third lens L3 has a concave object-side surface S5 and a convex image-side surface S6.

The fourth lens L4 has a concave object-side surface S7 and a convex image-side surface S8.

The fifth lens L5 has a concave object-side surface S9 and a concave image-side surface S10.

The aperture stop S, the first lens L1, the second lens L2, the third lens L3, the fourth lens L4, and the fifth lens L5 are disposed in fixed positions.

A cover glass plate CG is disposed between the fifth lens L5 and the image plane IMG.

Table 13 shows lens data in Numerical Example 4 in which specific values are used in the imaging lens 4 according to Example 4.

TABLE 13

| Si | Ri | Di | Ni | νi |
|---|---|---|---|---|
| 1 | 1.894 | 0.976 | 1.53 | 54.2 |
| 2 | 8.635 | 0.080 | | |
| 3 | −5.644 | 0.480 | 1.63 | 23.9 |
| 4 | −6.698 | 0.544 | | |
| 5 | −8.338 | 0.544 | 1.63 | 23.9 |
| 6 | −6.723 | 0.288 | | |
| 7 | −18.638 | 0.736 | 1.53 | 54.2 |
| 8 | −3.560 | 0.672 | | |
| 9 | −3.735 | 0.560 | 1.53 | 54.2 |
| 10 | 7.294 | 0.170 | | |
| 11 | INF | 0.160 | 1.5167 | 64.2 |
| 12 | INF | 0.600 | | |

In the imaging lens 4, the following surfaces are aspheric surfaces: both surfaces of the first lens L1 (first and second surfaces); both surfaces of the second lens L2 (third and fourth surfaces); both surfaces of the third lens L3 (fifth and sixth surfaces); both surfaces of the fourth lens L4 (seventh and eighth surfaces); and both surfaces of the fifth lens L5 (ninth and tenth surfaces). Tables 14 and 15 show the third to sixteenth aspheric coefficients A3 to A16 and the conic constant κ of the aspheric surfaces in Numerical Example 4.

Table 14 shows only the even-order aspheric constants, and Table 15 shows the even-order and odd-order aspheric constants.

TABLE 14

| Si | κ | Fourth | Sixth | Eighth | Tenth | Twelfth | Fourteenth | Sixteenth |
|---|---|---|---|---|---|---|---|---|
| 1 | 0.2930 | −1.209E−02 | 6.762E−03 | −2.355E−02 | 8.924E−03 | 7.91E−03 | −7.54E−03 | −2.23E−04 |
| 2 | 0.0000 | −2.323E−02 | −7.790E−03 | −4.107E−02 | −2.139E−02 | 2.04E−02 | 1.38E−02 | −8.28E−03 |
| 9 | −0.8430 | 4.822E−03 | 6.835E−04 | 1.726E−06 | −3.012E−06 | 0.000E+00 | 0.000E+00 | 0.000E+00 |

TABLE 15

| Si | κ | Third | Fourth | Fifth | Sixth | Seventh |
|---|---|---|---|---|---|---|
| 3 | 12.9000 | 4.38E−02 | 4.58E−02 | −1.17E−01 | 2.08E+00 | −4.73E+00 |
| 4 | 0.0000 | 5.77E−02 | 3.43E−02 | 5.53E−01 | 1.44E−01 | −5.21E−01 |
| 5 | 22.5000 | 3.85E−02 | −6.81E−02 | −8.74E−02 | 2.26E−01 | 9.73E−02 |
| 6 | 0.0000 | −4.80E−02 | −2.56E−01 | −1.61E−02 | 2.25E−02 | 1.80E−01 |
| 7 | 0.0000 | 1.07E−01 | −5.97E−01 | 2.48E−01 | −6.97E−02 | 1.95E−02 |
| 8 | 0.0000 | 2.01E−01 | −1.09E−01 | −4.79E−03 | −7.78E−03 | 3.95E−03 |
| 10 | −49.5000 | 2.13E−02 | −3.84E−02 | −6.92E−03 | 9.10E−03 | −2.57E−03 |

| Si | Eighth | Ninth | Tenth | Eleventh | Twelfth |
|---|---|---|---|---|---|
| 3 | 3.40E+00 | −2.87E+00 | 2.94E+00 | 0.000E+00 | 0.000E+00 |
| 4 | −5.58E−01 | −2.65E−01 | 1.99E+00 | 0.000E+00 | 0.000E+00 |
| 5 | −8.68E−01 | 1.27E+00 | −7.19E−01 | 0.000E+00 | 0.000E+00 |
| 6 | 1.60E−01 | −4.54E−02 | −1.18E−01 | 0.000E+00 | 0.000E+00 |
| 7 | 5.08E−02 | 2.85E−02 | −1.86E−02 | −1.92E−02 | 7.31E−03 |
| 8 | 2.14E−04 | −2.81E−03 | 2.25E−03 | 2.37E−05 | 1.17E−04 |
| 10 | −4.87E−03 | 2.22E−04 | 8.37E−04 | 0.00E+00 | 0.00E+00 |

Table 16 shows the focal length f, the f-number Fno, and the half viewing angle ω in Numerical Example 4.

TABLE 16

| | |
|---|---|
| f | 4.50 |
| Fno | 2.6 |
| ω (°) | 35 |

FIG. 8 shows aberrations in Numerical Example 4.

In the spherical aberration diagram in FIG. 8, the vertical axis represents the proportion with respect to the full-aperture f-number, and the horizontal axis represents the amount of defocus. The solid line represents spherical aberration values at the g line (wavelength of 435.83 nm), the dotted line represents spherical aberration values at the d line (wavelength of 587.56 nm), and the chain line represents spherical aberration values at the F line (wavelength of 486.13 nm). In the astigmatism diagram in FIG. 8, the vertical axis represents the viewing angle, and the horizontal axis represents the amount of defocus. The solid line represents astigmatism values in the sagittal image plane at the d line, and the broken line represents astigmatism values in the meridional image plane at the d line. In the field curvature diagram in FIG. 8, the vertical axis represents the viewing angle, and the horizontal axis represents %. The solid line represents field curvature values at the d line.

The aberration diagrams clearly show that the aberrations have been satisfactorily corrected and excellent imaging performance has been achieved in Numerical Example 4.

### [Values for Variables in Imaging Lens Conditional Expressions]

A description will be made of values for the variables in the conditional expressions for the imaging lenses according to Examples of the present technology.

Table 17 shows values for the variables in the conditional expressions (1) to (4) for the imaging lenses 1 to 4.

TABLE 17

| | | Imaging | Imaging | Imaging | Imaging |
|---|---|---|---|---|---|
| | | lens 1 | lens 2 | tens 3 | lens 4 |
| | f1 | 3.525 | 3.259 | 3.389 | 4.320 |
| | f4 | 6.542 | 6.848 | 5.371 | 8.094 |
| Conditional | 0.45 < f1/f4 < | 0.54 | 0.48 | 0.63 | 0.53 |
| expression (1) | 0.70 | | | | |
| | f123 | 5.501 | 5.208 | 6.022 | 4.546 |
| | fa | 5.25 | 5.01 | 4.90 | 4.50 |
| Conditional | 0.9 < f123/fa < | 1.05 | 1.04 | 1.28 | 1.00 |
| expression (2) | 1.5 | | | | |
| | f234 | 18.249 | 42.909 | 23.968 | 7.189 |
| Conditional | 1.5 < f234/fa < | 3.49 | 8.78 | 4.95 | 1.53 |
| expression (3) | 9.0 | | | | |
| | f34 | 8.561 | 10.406 | 9.719 | 6.890 |
| Conditional | 1.5 < f34/fa < | 1.63 | 2.08 | 1.98 | 1.53 |
| expression (4) | 2.5 | | | | |

Table 17 clearly shows that the imaging lenses 1 to 4 are configured to satisfy the conditional expressions (1) to (4).

### [Configuration of Imaging Apparatus]

An imaging apparatus according to an embodiment of the present technology includes an imaging lens formed of an aperture stop, a first lens having positive power and a concave image-side surface, a second lens having negative power and a concave object-side surface, a third lens having negative power, a fourth lens having positive power, and a fifth lens having negative power sequentially arranged from the object side toward the image side.

In the thus configured imaging lens of the imaging apparatus according to the embodiment of the present technology, in which the aperture stop is disposed in a position shifted from the first lens toward the object side, an entrance pupil can be set in a position far away from the image plane, whereby a high degree of telecentricity can be ensured and hence the angle of incidence with respect to the image plane can be set in a preferable manner.

Further, in the imaging apparatus according to the embodiment of the present technology, since the imaging lens has a five-lens configuration formed of the first lens, the second lens, the third lens, the fourth lens, and the fifth lens, each of the lenses can be designed to correct one type of aberration, whereby the imaging lens as a whole can satisfactorily correct aberrations to improve its optical performance.

Moreover, in the imaging lens of the imaging apparatus according to the embodiment of the present technology, in which the image-side surface of the first lens has a concave shape and the object-side surface of the second lens has a concave shape, the first lens and the second lens can be so disposed that the distance therebetween is minimized, whereby the total optical length can be shortened.

Still further, in the imaging lens of the imaging apparatus according to the embodiment of the present technology, in which the third lens in the five-lens configuration has negative power, the total thickness of the imaging lens can be reduced, whereby the total optical length can be further shortened.

As described above, the imaging lens of the imaging apparatus according to the embodiment of the present technology, in which the aperture stop and the positive, negative, negative, positive, and negative five lenses are sequentially arranged from the object side toward the image side, and the image-side surface of the first lens has a concave shape and the object-side surface of the second lens has a concave shape, allows the total optical length to be shortened with an improvement in optical performance achieved.

### [Embodiment of Imaging Apparatus]

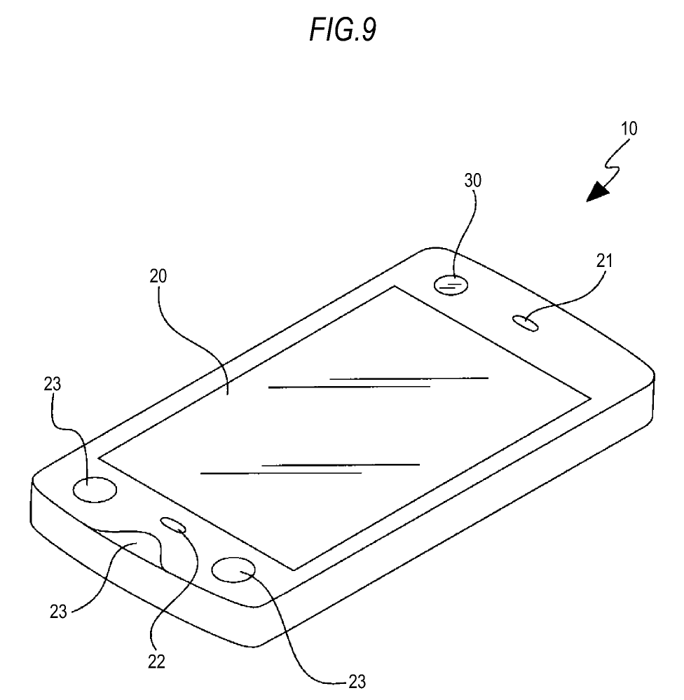

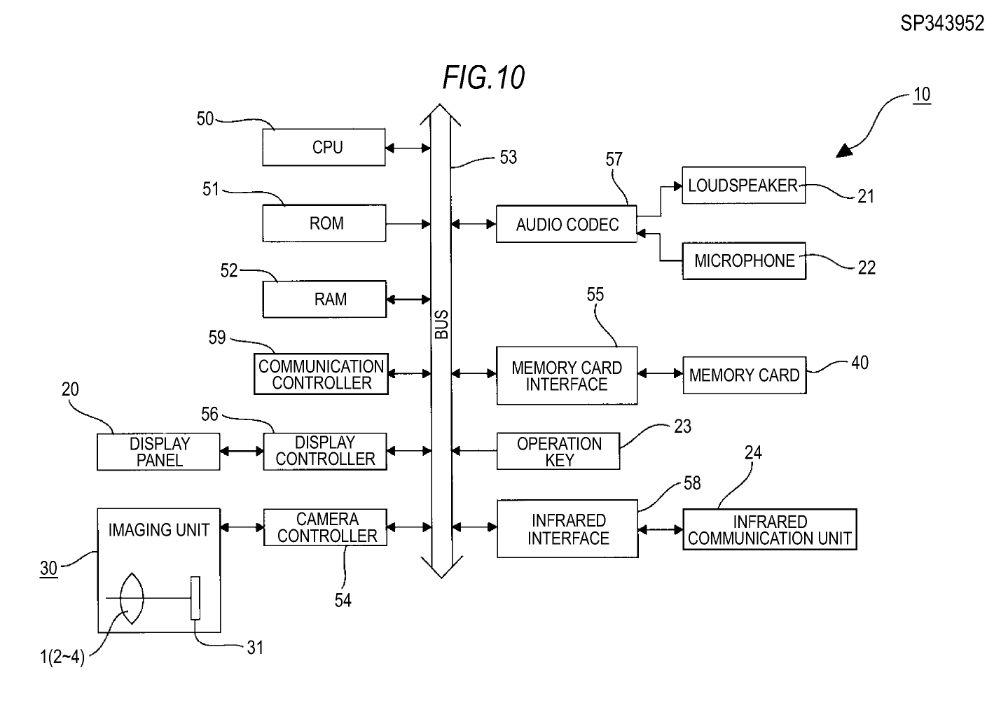

A description will next be made of a case where the imaging apparatus according to the embodiment of the present technology is used as a mobile phone (see FIGS. 9 and 10).

On one surface of a mobile phone 10 are provided a display panel 20, a loudspeaker 21 and a microphone 22, and operation keys 23, 23, . . . . An imaging unit 30 including the imaging lens 1, the imaging lens 2, the imaging lens 3, or the imaging lens 4 is incorporated in the mobile phone 10.

The imaging unit 30 includes an imaging device 31, such as a CCD (charge coupled device) and a CMOS (complementary metal oxide semiconductor) device, as well as the imaging lens 1, the imaging lens 2, the imaging lens 3, or the imaging lens 4.

The mobile phone 10 further includes an infrared communication unit 24 for infrared-based communication.

A memory card 40 is inserted into and removed from the mobile phone 10.

The mobile phone 10 further includes a CPU (central processing unit) 50, which controls the operation of the entire mobile phone 10. For example, the CPU 50 loads a control program stored in a ROM (read only memory) 51 into a RAM (random access memory) 52 and uses the control program to control the operation of the mobile phone 10 via a bus 53.

A camera controller 54 has a function of controlling the imaging unit 30 to capture a still image or motion pictures. The camera controller 54 compresses captured image information based, for example, on JPEG (Joint Photographic Experts Group) and MPEG (Moving picture Experts Group) and then sends the compressed data to the bus 53.

The image information sent to the bus 53 is temporarily saved in the RAM 52, outputted to a memory card interface 55 as necessary and saved in the memory card 40 via the memory card interface 55, or displayed on the display panel 20 via a display controller 56.

In image capturing operation, audio information captured through the microphone 22 is simultaneously saved temporarily in the RAM 52 via an audio codec 57 or saved in the memory card 40 and outputted through the loudspeaker 21 via the audio codec 57 simultaneously with the operation of displaying an image on the display panel 20.

The image information and the audio information are outputted to an infrared interface 58 as necessary, outputted to an external apparatus via the infrared interface 58 and the infrared communication unit 24, and transmitted to other apparatus including an infrared communication unit, such as a mobile phone, a personal computer, and a PDA (personal digital assistant). To display motion pictures or a still image on the display panel 20 based on image information saved in the RAM 52 or the memory card 40, the camera controller 54 decodes and decompresses a file saved in the RAM 52 or the memory card 40 and then sends the resultant image data to the display controller 56 via the bus 53.

A communication controller 59 sends and receives radio waves to and from a base station via an antenna (not shown). In a voice call mode, the communication controller 59 processes received audio information and then outputs the processed audio information to the loudspeaker 21 via the audio codec 57, collects audio through the microphone 22, receives the collected audio via the audio codec 57, performs predetermined processing on the received audio, and then sends the processed audio.

Since the imaging lens 1, the imaging lens 2, the imaging lens 3, and the imaging lens 4 allow the total optical length to be shortened as described above, any of the imaging lenses can be readily incorporated in an imaging apparatus that needs to be thin, such as the mobile phone 10.

The above embodiment has been described with reference to the case where the imaging apparatus is used as a mobile phone, but the imaging apparatus is not necessarily used as a mobile phone. The imaging apparatus can be widely used as a digital input/output apparatus, such as a digital video camcorder, a digital still camera, a personal computer in which a camera is incorporated, and a PDA (personal digital assistant) in which a camera is incorporated.

### [Others]

In any of the imaging lenses according to the embodiments of the present technology and the imaging apparatus according to the embodiment of the present technology, a lens with no power, an aperture stop, and other optical elements may be disposed as well as the first to fifth lenses. In this case, the lens configuration of the imaging lens according to any of the embodiments of the present technology is a five-lens configuration formed of the first to fifth lenses.

### [Present Technology]

The present technology can also be configured as follow.

<1> An imaging lens including, in the order an object side toward an image side: an aperture stop, a first lens having positive power and a concave image-side surface, a second lens having negative power and a concave object-side surface, a third lens having negative power, a fourth lens having positive power, and a fifth lens having negative power.

<2> The imaging lens described in <1>,

wherein the second lens has a concave image-side surface.

<3> The imaging lens described in <1> or <2>,

wherein the imaging lens satisfies the following conditional expression (1):

0.45<f1/f4<0.70 (1)

where f1 represents the focal length of the first lens, and f4 represents the focal length of the fourth lens.

<4> The imaging lens described in any of <1> to <3>,

wherein the imaging lens satisfies the following conditional expression (2):

0.9<f123/fa<1.5 (2)

where f123 represents the combined focal length of the first lens, the second lens, and the third lens, and fa represents the focal length of the entire lens system.

<5> The imaging lens described in any of <1> to <4>,

wherein the imaging lens satisfies the following conditional expression (3):

1.5<f234/fa<9.0 (3)

where f234 represents the combined focal length of the second lens, the third lens, and the fourth lens, and fa represents the focal length of the entire lens system.

<6> The imaging lens described in any of <1> to <5>,

wherein the imaging lens satisfies the following conditional expression (4):

1.5<f34/fa<2.5 (4)

where f34 represents the combined focal length of the third lens and the fourth lens, and fa represents the focal length of the entire lens system.

<7> The imaging lens described in any of <1> to <6>,

wherein each of the second lens and the third lens is made of a material having an Abbe number smaller than or equal to 31.

<8> The imaging lens described in <4>,

wherein the upper limit of the conditional expression (2) is 1.4.

<9> The imaging lens described in <6>,

wherein the upper limit of the conditional expression (4) is 2.25.

<10> An imaging apparatus including an imaging lens and an imaging device that converts an optical image formed by the imaging lens into an electric signal,

wherein the imaging lens includes, in the order from an object side toward an image side: an aperture stop, a first lens having positive power and a concave image-side surface, a second lens having negative power and a concave object-side surface, a third lens having negative power, a fourth lens having positive power, and a fifth lens having negative power.

<11> The imaging lens described in any of <1> to <9> or the imaging apparatus described in <10>,

wherein an optical element including a lens having substantially no power is further disposed.

The shapes and values of the components shown in Examples described above are all presented only by way of example for implementing the present technology and should not be used to construe the technical range of the present technology in a limited sense.

The present disclosure contains subject matter related to that disclosed in Japanese Priority Patent Application JP 2012-056250 filed in the Japan Patent Office on Mar. 13, 2012, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An imaging lens comprising, in the order from an object side toward an image side:
an aperture stop;
a first lens having positive power and a concave image-side surface;
a second lens having negative power and a concave object-side surface;
a third lens having negative power;
a fourth lens having positive power; and
a fifth lens having negative power.

2. The imaging lens according to claim 1,
wherein the second lens has a concave image-side surface.

3. The imaging lens according to claim 1,
wherein the imaging lens satisfies the following conditional expression (1):
0.45<f1/f4<0.70 (1)
where f1 represents the focal length of the first lens, and f4 represents the focal length of the fourth lens.

4. The imaging lens according to claim 1,
wherein the imaging lens satisfies the following conditional expression (2):
0.9<f123/fa<1.5 (2)
where f123 represents the combined focal length of the first lens, the second lens, and the third lens, and fa represents the focal length of the entire lens system.

5. The imaging lens according to claim 1,
wherein the imaging lens satisfies the following conditional expression (3):
1.5<f234/fa<9.0 (3)
where f234 represents the combined focal length of the second lens, the third lens, and the fourth lens, and fa represents the focal length of the entire lens system.

6. The imaging lens according to claim 1,
wherein the imaging lens satisfies the following conditional expression (4):
1.5<f34/fa<2.5 (4)
where f34 represents the combined focal length of the third lens and the fourth lens, and fa represents the focal length of the entire lens system.

7. The imaging lens according to claim 1,
wherein each of the second lens and the third lens is made of a material having an Abbe number smaller than or equal to 31.

8. The imaging lens according to claim 4,
wherein the upper limit of the conditional expression (2) is 1.4.

9. The imaging lens according to claim 6,
wherein the upper limit of the conditional expression (4) is 2.25.

10. An imaging apparatus comprising:
an imaging lens; and
an imaging device that converts an optical image formed by the imaging lens into an electric signal,
wherein the imaging lens includes, in the order from an object side toward an image side:
an aperture stop,
a first lens having positive power and a concave image-side surface,
a second lens having negative power and a concave object-side surface,
a third lens having negative power,
a fourth lens having positive power, and
a fifth lens having negative power.
